(19) United States
(12) Patent Application Publication
(10) Pub. No.: US 2018/0172987 A1
(43) Pub. Date: Jun. 21, 2018

(54) Modulated Optical Technique for Focus Stacking Images in Imaging Systems

(71) Applicant: SPAWAR Systems Center Pacific, San Diego, CA (US)

(72) Inventors: Bienvenido Melvin L. Pascoguin, La Mesa, CA (US); Ryan P. Lu, San Diego, CA (US); Richard Nguyen, Escondido, CA (US); Ayax D. Ramirez, Chula Vista, CA (US)

(73) Assignee: United States of America as represented by Secretary of the Navy, San Diego, CA (US)

(21) Appl. No.: 15/381,359

(22) Filed: Dec. 16, 2016

(51) Int. Cl. G02B 27/00; G02B 7/04; G02B 23/00

(52) U.S. Cl. CPC G02B 27/0075; G02B 23/00; G02B 7/04

(57) ABSTRACT

A system and method for focus-stacking images that results in a clearer image, particularly where objects in the image are at different depths of field. The system and method may be used in connection with, or made a part of, an imaging system, including a telescope, camera, binoculars or other imaging system. The system and method incorporate one or more focus-altering devices that alter the focus of an image produced by the imaging system. The system and method also incorporate a modulation device that modulates between two or focal planes, thereby resulting in a focus-stacked image that is a combination of two or more focal planes.

### FEDERALLY-SPONSORED RESEARCH AND DEVELOPMENT

The United States Government has ownership rights in this invention. Licensing inquiries may be directed to Office of Research and Technical Applications, Space and Naval Warfare Systems Center, Pacific, Code 72120, San Diego, Calif., 92152; telephone (619) 553-5118; email: ssc_pac_t2@navy.mil. Reference Navy Case No. 103,124.

### BACKGROUND OF THE INVENTION

### Field of Invention

This disclosure relates to imaging systems, and more particularly, focus-stacking in imaging systems.

### Description of Related Art

Problems may arise in imaging systems when they capture multiple objects at different depths of field or focus. As used herein, depth of field (sometimes referred to hereinafter as “extended depth of focus”) refers to the distance between objects closest to an imaging system and objects farthest from an imaging system that give a focused image. Different depths of field may require different focal planes. Due to the different depths of field in a single image, the captured image may have one or more objects in focus at one depth of field, while one or more other objects located at other depths of field may appear out of focus. Thus, it may be desirable to extend the depth of field of an imaging system so that as many objects as possible are in focus.

Numerous methods and techniques have been used to address this problem and achieve extended depth of field (EDOF). For example, some EDOF prior art systems involve passing the images through pinholes. Using this EDOF technique, lenses may focus light through “pinhole” apertures, thus extending the depth of field.

Another example of a prior art EDOF technique involves using cubic phase masks. Cubic phase masks may be used to generate optical aberrations in imaging systems. Such aberrations may cause the image to be blurred in a substantially uniform manner. Thereafter, digital processing may be used to restore the substantially uniformly blurred image into better focus.

Still other prior art systems incorporate Fourier transform pupil functions to tailor the EDOF. Using this prior art EDOF technique, specially designed pupil functions are generated in order to obtain desired depth of field distributions.

However, all the above-mentioned approaches have drawbacks in that they require post processing of the subject image. The above-referenced EDOF techniques may also reduce the focus of the image because the beam waist of the focus is being broadened and the theoretical beam waist at focus is small. Due to the distortion of the image, digital image processing is used to correct the image, thus introducing further delay in rendering the image. There is a need for an imaging technique that achieves better focus without digital signal processing or digital image processing.

Another method used to solve the EDOF problem is the technique used in more recent light field cameras. After processing on a computer, a light field camera may permit a user to refocus images, e.g., on the foreground, middle distance, or background. However, the light field camera has limitations. First, it can only focus on one plane at a time after the image has been captured, not at the time the image is captured. Second, this imaging system relies heavily on post processing. Third, the light field camera may use a more expensive camera sensor to capture more light. Accordingly, there is still further a need for a method for solving the EDOF problem that does not heavily rely on post-processing, and that does not require an expensive camera sensor.

### BRIEF SUMMARY OF INVENTION

The present disclosure addresses the needs noted above by providing a system and method that incorporate modulated optical techniques for focus stacking images in order to address EDOF issues.

In accordance with one embodiment of the present disclosure, a system is provided for focus-stacking images. The system comprises an imaging system, and one or more focus-altering devices configured to alter, over multiple focal planes, the focus of an image generated by the imaging system. The system also comprises a modulation device operably coupled to the imaging system, the modulation device being configured to modulate between two or more focal planes, thereby resulting in a stacked or blended image that is a combination of the two or more focal planes.

These, as well as other objects, features and benefits will now become clear from a review of the following detailed description, the illustrative embodiments, and the accompanying drawings.

### BRIEF DESCRIPTION OF DRAWINGS

The accompanying drawings, which are incorporated in and form a part of the specification, illustrate example embodiments and, together with the description, serve to explain the principles of the invention. In the drawings:

FIG. 1 illustrates optical elements of an imaging system that may be used to aid in focus-stacking an image in accordance with one embodiment of the present disclosure.

FIG. 2 illustrates a system for focus-stacking an image in accordance with one embodiment of the present disclosure.

FIG. 3A illustrates a single image taken at one focal point, while FIG. 3B illustrates that same image taken at a different focal point, thus illustrating a focusing problem that is addressed by the present disclosure.

FIG. 4A illustrates an original image, and FIG. 4B illustrates a focus-stacked image in accordance with one embodiment of the present disclosure.

FIG. 5 illustrates the steps of a method for focus-stacking an image in accordance with one embodiment of the present disclosure.

### DETAILED DESCRIPTION OF THE INVENTION

Disclosed herein are a method and system that focus-stack images in real time in order to enhance image focus, particularly where the image has objects at different depths of field. The system and method may be used in connection with—or made a part of—an imaging system, including a telescope, camera, binoculars or other imaging system. The system and method incorporate one or more focus-altering devices that alter the focus of an image produced by the imaging system. For example, using the focus-altering device at one focal plane, objects may be clearly viewed at a distance. At another focal plane, objects may be clearly viewed nearby.

The system and method incorporate a modulated optical technique to modulate between two or more focal planes, thereby resulting in a focus-stacked image that is a combination of two or more focal planes. In fact, the present system and method permit focus over a number of focal planes at different depths of field. For example, if an image were to include people or objects lined up from fifty yards to one hundred yards from a camera, the present system and method permit all of the people or objects to be in focus, whether they are at fifty yards, sixty-five yards, eighty yards, or one hundred yards from the camera.

The system and method achieve ultra-high depth of field/(UHDOF) so that focus is enhanced for essentially any object, person or other subject matter within the field of view of an imaging system. With UHDOF, the depth of field is essentially the farthest focus achievable by the imaging system.

The system and method described herein, in the most general embodiment, achieve UHDOF for essentially any imaging system in real time with little to no post-processing. Unlike the prior art light field cameras, the system and method described herein naturally blend/combine the multiple focal planes into one UHDOF image and do not necessarily require a very sensitive camera sensor to capture all of the light.

Two main aspects of the system and method involve focus-altering and modulation. The system and method use one or more focus-altering devices such as spatial light modulators (SLMs), deformable mirrors (DMs). The different focuses are combined for viewing different ranges. The system and method combine those different ranges by modulating between two or more object focal planes to present a focus-stacked image in real time. The focus-stacked image is a combination of the different object focal planes onto a single image focal plane.

In order to achieve ideal focus, a single image focal plane is desired. The present system and method take advantage of the human eye's inability to discern that the image is being quickly modulated at multiple focuses in a single image focal plane. In this manner, to the naked eye, the modulated (focus-stacked) image appears as a single image. Thus, it may be desirable for the frequency of modulation to be sufficiently high that the eye does not detect that there are multiple focal planes in the image. As one example, it may be desirable for the frequency to occur at about sixty hertz (60 Hz) for two images, or about thirty hertz (30 Hz) for each image. Since video may be about thirty frames per second (30 fps) and there are two images, then 60 Hz may be a suitable speed for the eye to perceive dual focal planes as essentially a single image. For additional foci, an additional increase in frequency may be desired. For example, thirty additional hertz may be added for each additional focal plane.

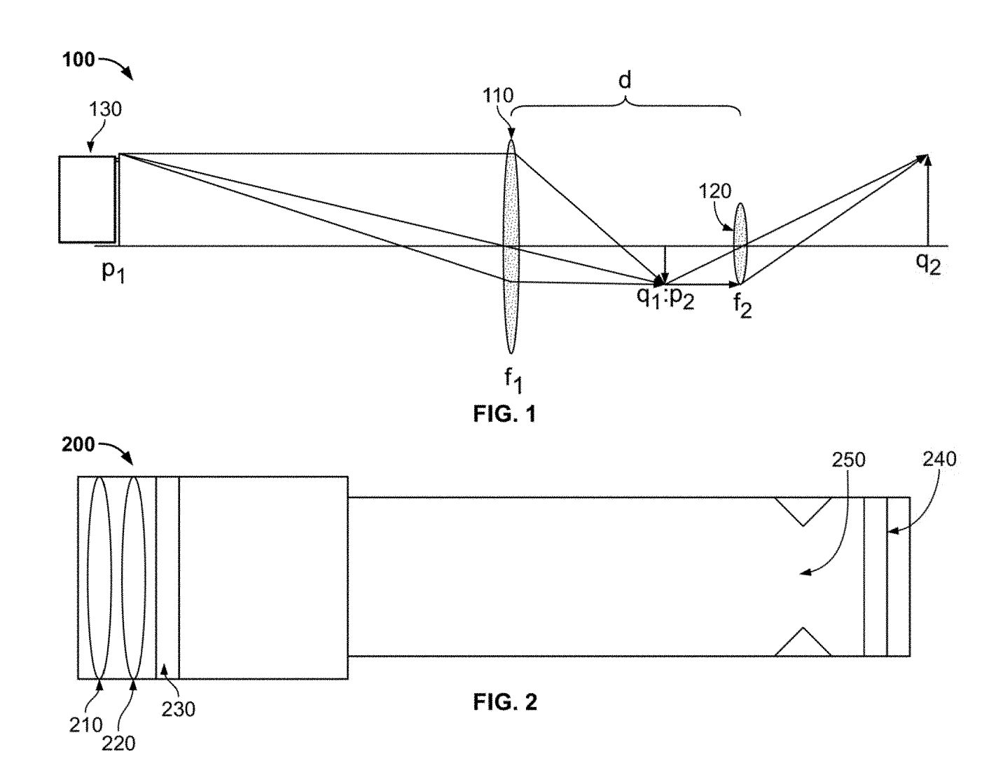

In one embodiment of the focus-stacking system, the imaging system may be a telescope. Referring now to FIG. 1, illustrated are the optical elements of a telescope that can be used to enhance focus in accordance with one embodiment of the present disclosure. The optical elements shown in FIG. 1 represent a simplistic two-lens telescope design. The collector lens 110 collects the light rays of the image, the magnifier lens 120 (or the eyepiece) magnifies the image. The collector lens 110 may have a longer focal length than the magnifier lens 120. By changing the properties of the two lenses (or just one of the components), e.g., by altering the focus of the magnifier lens 120, the telescope will change such that the focal plane is at a different range. By modulating the focus plane between two or more focal planes, the resulting image is a natural blend of the two or more focal planes simultaneously focused on the same plane without the use of an image processing algorithm.

The Keplerian telescope is used as an example in FIG. 1. Examples of telescopic arrangements other than the Kepler telescopic arrangement shown in FIG. 1 are Newtonian, Galilean, and Cassegrain-type telescopic arrangements which are well-known in the art. It should be understood that the method and system described herein are not limited to telescopes. For example, the method and system can be expanded to include microscopes, bio-imaging and essentially any other imaging system.

The telescopic example of optical elements in FIG. 1 includes two optical lenses. The lens on the left is the collector lens 110 and the lens on the right is the magnifier lens 120. Also shown is an object 130 to be imaged by this imaging system. Depending on the relative position and focus of the collector lens 110 and the magnifier lens 120, the resulting image location and magnification will also change. These changes are determined by the laws of diffraction or the lens maker equation shown below.

$$\begin{matrix}\frac{1}{f} = \frac{1}{p} + \frac{1}{q} & ( Equation 1 ) \\ M = - \frac{q}{p} & ( Equation 2 )\end{matrix}$$

where f is the focus of the lens, p is the distance of the object, q is the distance of the image and M is magnification.

In the Keplerian telescope, the lens maker equation may be used twice because there are two lenses. By applying the lens maker equation, one can approach the conclusion that by changing the focal length of the eyepiece, the magnification of the image will change. More specifically, the approximate magnification of a two lens imaging system is shown below.

$$M \text{∼} \frac{f 1}{f 2} \qquad ( Equation 3 )$$

where f₁ and f₂ are the focal lengths of the two lenses. The range of the object can be modified by changing the relative distance of the two lenses. This method of modifying the image magnification and object range is suitable for many, if not all, imaging systems.

One of the ways to modify the characteristics of a lens is to use SLMs or DMs. A specific type of SLM is the Liquid Crystal SLM (LCSLM), where materials that are highly birefringent are manipulated by applying electric fields to change the birefringence of a single pixel. Birefringence is directly related to the phase change induced in light waves. In scalar diffraction theory, a lens is thought of as a quadratic phase material. Thus, by emulating a proper quadratic phase pattern on an LCSLM, a new lens with a new focal length can be emulated. The combination of LCSLM and a lens can modify the effective focus of the lens. Current LCSLMs are as fast as 240 Hz, thus the modulation rate may be somewhat limited by this technology.

Referring now to FIG. 2, illustrated is a system for focus-stacking images to enhance focus in accordance with one embodiment of the present disclosure. In this example, the imaging system is a telescope 200 that is used to focus-stack images as described herein. The telescope 200 includes a collector lens 210, a magnifier lens 220 (or eyepiece) and an SLM 230 at one end. The SLM 230 is positioned next to the magnifier lens 220 in order to effect a change in the image received at the magnifier lens 220 and thus, the SLM 230 is operably coupled to the magnifier lens 220. Examples of SLMs that may be used with the present system and method are polarization independent liquid crystal on silicon spatial light modulators and polarization independent spatial light modulators. A wide range of deformable mirrors may be used to carry out the present system and method.

The SLM 230 alters the focus of an image produced by the telescope 200. The SLM 230 may be used to modulate between two or continuous object focal planes, thereby resulting in a focus-stacked image that is a natural blend or combination of multiple (or continuous) object focal planes that are simultaneously focused. To the eye (or image plane), this focus may appear to be on the same plane. SLM 230 may be used to modulate by switching the phase pattern of the SLM 230. One phase pattern may determine a single focus. Another phase pattern may determine another focus. Fresnel lenses with different patterns may also be used to vary the focal length and enhance focus. Different types of patterns can mimic different types of lenses. The modulation may occur based on a pattern, e.g., those presented via SLM 230 or a DM (not shown in FIG. 2).

Alternatives are available to the SLM 230. In lieu of the SLM 230, in order to accomplish this modulation, the magnifier lens 220 may be physically or mechanically moved back and forth along the center of the magnifier lens 220 or left and right to achieve different focal lengths. One way to accomplish this movement is via a small piston that moves back and forth. Another way to accomplish this movement is through adaptive zoom lenses that incorporate an ultrasonic piezoelectric actuator to electro-mechanically change the lens curvature. This physical movement may alter the focus or magnification of the imaging system. The pattern of the SLM 230 may also alter the focus of the imaging system. The SLM 230 may be used to change the index of refraction of each pixel, thus changing the focus of an object in an image. When an image is projected to the SLM 230, it may change the pattern and image and index of refraction of each pixel.

In lieu of both the collector lens 210 and magnifier lens 220, it may be possible to have a single positive lens that moves to accomplish different focuses of objects at different depths of field in the image. In fact, no lens may be needed at all if there were an SLM 230 with the appropriate pattern to accommodate the desired focal lengths. If SLM 230 has a high change of index of refraction, then no lens may be necessary.

In the embodiment shown in FIG. 2, the telescope 200 also includes a sensor 240 and aperture 250. It should be noted that not all imaging systems would include aperture 250. Therefore, where no aperture is needed for the imaging system, the aperture would not be needed to accomplish the system and method described herein. It should be further noted that not all imaging systems would require a sensor. Binoculars are one example of such an imaging system that does not require a sensor. Where no sensor is needed for the imaging system, it is not needed to accomplish the system and method described herein.

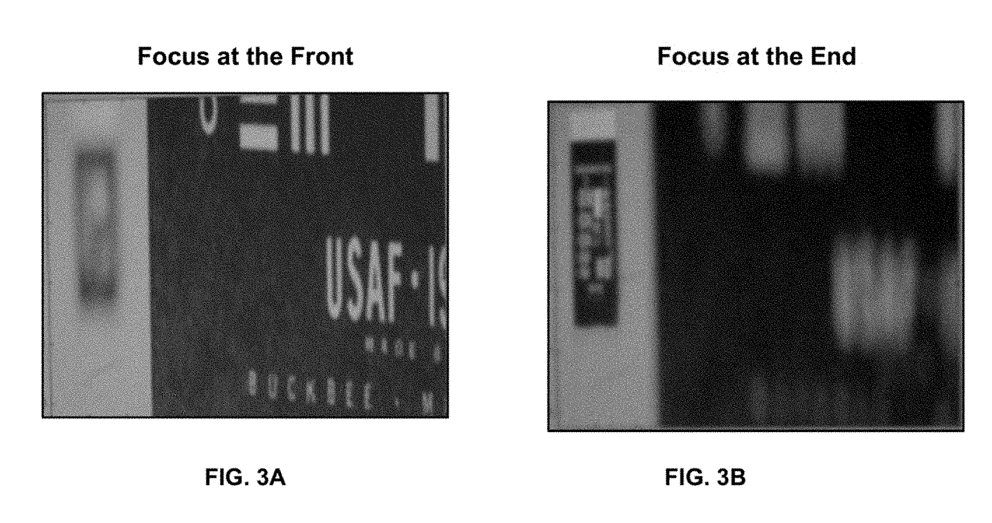

Referring now to FIGS. 3A and 3B, illustrated is a single image taken at two different focal lengths or foci. In FIG. 3A, the image on the left is focused near-field. In FIG. 3B, the image on the right is focused far-field. The relative distance between the two foci in FIG. 3A versus FIG. 3B is about three meters (3 m) and the camera is about 0.2 meters away from the near-field. These images are used to show a proof of concept of naturally blending foci at UHDOF.

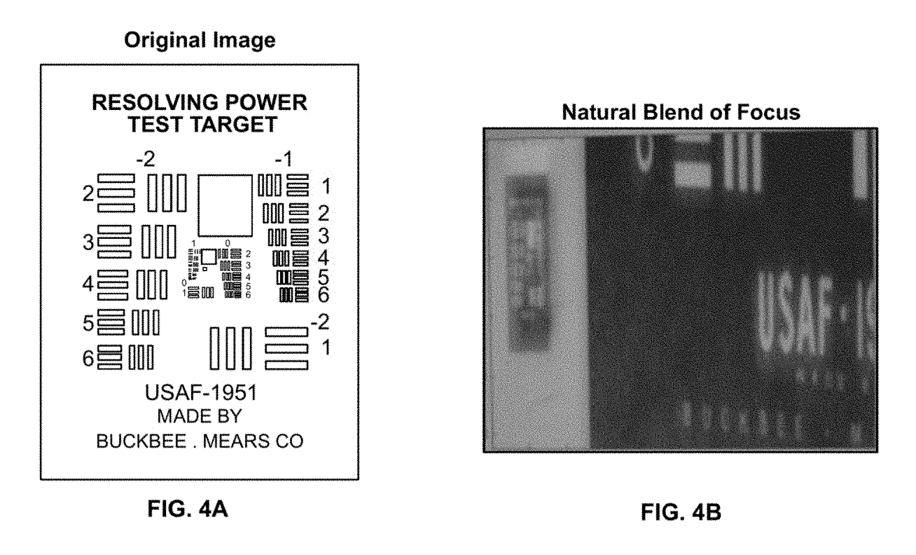

Referring now to FIG. 4A, illustrated is an original image. Referring now to FIG. 4B, illustrated is a naturally blended image in accordance with one embodiment of the present disclosure. The natural foci blending may be simulated using commercially available software to flicker between the images shown in FIG. 3. A small script may be written in order to accomplish this flickering. Then, another camera is used to take a relatively longer exposure to show that indeed the two images are naturally blended onto a single image without post processing. The present system and method are not limited to two foci but can be extended to focus over a long astronomical distance.

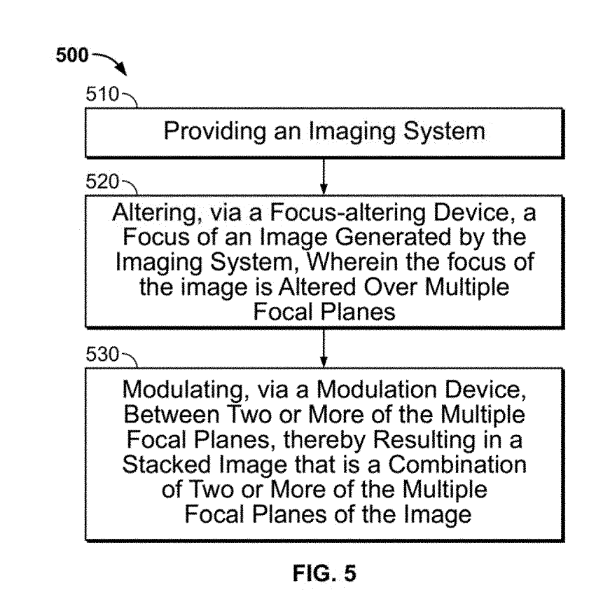

Referring now to FIG. 5, illustrated is a flow chart for a method for focusing an image in accordance with one embodiment of the present disclosure. At step 510, the method includes providing an imaging system. As noted above, the imaging system may be any type of imaging system. At step 520, the method includes altering, via a focus-altering device, a focus of an image produced by the imaging system. At step 530, the method includes modulating, via a modulation device, a focal plane between two or more of the multiple focal planes, thereby resulting in a stacked image produced by the imaging system being a combination of two or more of the multiple focal planes.

The present disclosure provides a novel method to naturally blend or combine foci at UHDOF without the use of post processing. Old methods of EDOF use highly pixelated cameras and heavy post-processing techniques to generate an image. The present disclosure provides not only EDOF, but goes into UHDOF. Existing post processing techniques and highly pixelated cameras can be used in combination with this invention to produce a hybrid fusion of UHDOF. As mentioned above, SLMs or DMs can be used to modify a lens to modulate the image of the object. But mechanical modulation of the physical optics is also a viable option to modulate an image. SLMs and DMs have limitations on how fast and how much phase can be introduced to the imaging system but mechanical modulation can further modulate the image in question.

The present system and method are adaptable for many existing imaging systems. For example, using the system and method described herein, a spatial light modulator (SLM) or deformable mirror (DM) may be added to an existing imaging system, thus accomplishing focus-altering and modulation. This focus-altering and modulation provide an extended depth of field for the imaging system by combining multiple focal planes into a single image plane.

The system and method described herein can be used for tracking multiple dynamic objects at different ranges, such as far field tracking and missile tracking. Existing auto-focus algorithms can be used to find the proper lens modulation technique to track different dynamic objects and dynamically modify the modulation to track the objects such that all of the objects of interest are in focus on a single image.

The system and method described herein can be used for clearing camp sites at a very far distance by viewing the sites and making sure they are secure. Current telescopic technology such as the finder scope is used for this application. But the finder scope uses a wide field of view, thus diminishing the quality of the focus. The system and method can be applied to a binocular design to modulate the range and naturally produce an image of high focus in real time to search fine details of a targeted camp at a distance.

The system and method described herein can be applied to photography in combination of post processing techniques to produce UHDOF. For example, in astrophotography small changes in the focal length of the eyepiece may drastically change the range of the plane of focus. The present system and method permit a user to capture multiple galactic images at different planes of field in a single image.

The foregoing description of various preferred embodiments have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed as new and desired to be protected by Letters Patent of the United States is:

1. A system for focus-stacking images, comprising:
an imaging system;
one or more focus-altering devices configured to alter, over multiple focal planes, the focus of an image generated by the imaging system;
a modulation device operably coupled to the imaging system, the modulation device being configured to modulate between two or more of the multiple focal planes, thereby resulting in a stacked image that is a combination of two or more of the multiple focal planes of the image.

2. The system of claim 1, wherein at least one of the one or more focus-altering devices is a spatial light modulator.

3. The system of claim 2, wherein the spatial light modulator is a liquid crystal spatial light modulator.

4. The system of claim 1, wherein at least one of the one or more focus altering devices is a deformable mirror.

5. The system of claim 1, wherein at least one of the one or more focus-altering devices alters the index of refraction for the image generated by the imaging system.

6. The system of claim 1, wherein the imaging system includes a collector lens and a magnifier lens.

7. The system of claim 1, wherein at least one of the one or more focus-altering devices physically moves the magnifier lens in relation to the collector lens.

8. The system of claim 1, wherein the imaging system is a telescope.

9. The system of claim 1, wherein the modulation device modulates at a modulation rate of at least thirty Hertz for each focal plane of the two or more focal planes.

10. A method for focus-stacking an image in an imaging system, the method comprising the steps of:
providing an imaging system;
altering, via a focus-altering device, a focus of an image generated by the imaging system, wherein the focus of the image is altered over multiple focal planes; and
modulating, via a modulation device, between two or more of the multiple focal planes, thereby resulting in a stacked image that is a combination of two or more of the multiple focal planes of the image.

11. The method of claim 10, wherein at least one of the one or more focus altering devices is a spatial light modulator.

12. The method of claim 11, wherein the spatial light modulator is a liquid crystal spatial light modulator.

13. The method of claim 10, wherein at least one of the one or more focus altering devices is a deformable mirror.

14. The method of claim 10, wherein at least one of the one or more focus-altering devices alters the index of refraction for the image that is generated by the imaging system.

15. The method of claim 10, wherein imaging system includes a collector lens and a magnifier lens.

16. The method of claim 10, wherein at least one of the one or more focus-altering devices physically moves the magnifier lens in relation to the collector lens.

17. A system for focus-stacking images, comprising:
an imaging system that includes a collector lens and a magnifier lens;
one or more focus-altering devices configured to alter, over multiple focal planes, the focus of an image generated by the imaging system;
a modulation device operably coupled to the imaging system, the modulation device being configured to modulate between two or more of the multiple focal planes at a rate of at least thirty hertz for each focal plane, thereby resulting in a stacked image that is a combination of two or more of the multiple focal planes of the image.

18. The system of claim 17, wherein at least one of the one or more focus altering devices is a spatial light modulator.

19. The system of claim 17, wherein the spatial light modulator is a liquid crystal spatial light modulator.

20. The system of claim 17, wherein at least one of the one or more focus altering devices is a deformable mirror.
